(19) United States
(12) Patent Application Publication
(10) Pub. No.: US 2007/0139729 A1
(43) Pub. Date: Jun. 21, 2007

(54) Image sensor and test system and method therefor

(76) Inventors: Gi-Doo Lee, Seoul (KR); Chi-Young Choi, Seoul (KR)

Correspondence Address: LAW OFFICE OF MONICA H CHOI, P O BOX 3424, DUBLIN, OH, 430160204, US

(21) Appl. No.: 11/635,999

(22) Filed: Dec. 8, 2006

(30) Foreign Application Priority Data
Dec. 16, 2005 (KR) 2005-124776

(51) Int. Cl. H04N 1/04

(52) U.S. Cl. 358/483; 382/312

(57) ABSTRACT

An image sensor includes a plurality of pixels each coupled to a respective analog-to-digital converter via a respective line. The image sensor also includes a first pad and a second pad. The first pad is coupled an external tester that applies a bias voltage on the respective line via the first pad. The second pad outputs the respective code corresponding to the bias voltage from the respective analog-to-digital converter to the external tester.

### BACKGROUND OF THE INVENTION

This application claims priority under 35 USC §119 to Korean Patent Application No. 2005-124776, filed on Dec. 16, 2005 in the Korean Intellectual Property Office, the disclosure of which is incorporated herein in its entirety by reference.

### 1. FIELD OF THE INVENTION

The present invention relates generally to image sensors, and more particularly, to accurately testing components of a CMOS (complementary metal oxide semiconductor) image sensor.

### 2. BACKGROUND OF THE INVENTION

In general, an image sensor is a semiconductor device for converting an optical image into electrical signals. Among such image sensors, a charge coupled device (CCD) image sensor continuously transmits charges stored in MOS capacitors designed for desired charge transfer characteristics. On the other hand, a CMOS (complementary metal oxide semiconductor) image sensor (CIS) includes a photodiode and MOSFETs (metal oxide semiconductor field effect transistors) forming unit pixels for sensing and amplifying signal charge representing received light.

The CMOS image sensor is formed from the CMOS fabrication process, which is simpler and of lower cost than for fabricating the CCD image sensor. In addition, a peripheral circuit such as a signal processing circuit may be formed in a single chip for the CMOS image sensor. Thus, the CMOS image sensor is viewed as the next generation image sensor.

The CMOS image sensor is generally divided into a CIS unit and an image signal processing (ISP) unit. The CIS unit generates a digital code representing an intensity of received light, and the ISP unit performs image processing to interpolate and reconstruct an image signal from the digital code generated by the CIS unit. The CIS unit and the ISP unit may be implemented on separate chips or on a single chip using a system on chip (SOC) technique.

The CIS unit includes an array of rows and columns of pixels arranged in a matrix configuration. Each pixel converts a charge induced by received light into a voltage value. An analog voltage generated from each pixel is converted into a digital code through correlated double sampling (CDS). The converted digital code is transferred to the ISP unit that reconstructs the image signal from the digital code.

A final output signal of the CMOS image sensor is generated from the ISP unit. Therefore, to thoroughly test the CMOS image sensor, the operation of the CIS unit and the ISP unit is desired to be characterized. Since the CMOS image sensor includes millions of unit pixels, testing for all data sensed from the pixels takes much time. Also, since the CIS unit performs many different image processing algorithms, testing of the CMOS image sensor may be complicated.

Due to the aforementioned problems, most test equipments perform the testing on the CIS unit and on the ISP unit, separately. For example, testing for data sensed by the CIS unit is independently performed during electrical die sorting (EDS), and testing for the ISP unit is independently performed through a vector. However, such individual testing does not reflect a whole operation characteristic of the CMOS image sensor including both the CIS unit and the ISP unit operating together. Therefore, reducing test time and complexity for testing the CMOS image sensor is desired including testing the full data path through the CIS unit and the ISP unit.

Also, since the CMOS image sensor generates image signals from light generated externally, directly testing the performance of components of the CMOS image sensor may be difficult. In order to measure the performance of the components (e.g., ramp signal generator, analog-digital converter, etc.) used for converting voltages generated from the pixels into digital codes, light illuminated onto the CMOS image sensor should be controlled. For example, for verifying the performance for a whole operating range of the components, the intensity of light illuminated onto the pixels is desired to be varied incrementally. However, such control of light may be difficult and costly.

U.S. Pat. No. 6,903,670 to Lee et al. discloses noise compensation circuitry that applies a voltage at nodes of the unit pixels of a CMOS image sensor for determining a proper level of noise compensation. Korean Patent Application Nos. 1020030007741 and 1020030027030 disclose generation of voltage on-chip for use during testing of the CMOS image sensor. However, such CMOS image sensors each include added switching elements and voltage generators on-chip within the CMOS image sensor itself. Including such additional components within the CMOS image sensor disadvantageously enlarges the integrated circuit area and complexity of the CMOS image sensor.

### SUMMARY OF THE INVENTION

The present invention provides a CMOS image sensor and a system and method for reducing test time and complexity during testing the CMOS image sensor.

An image sensor according to an embodiment of the present invention includes a plurality of pixels each coupled to a respective line and a respective analog-to-digital converter. The respective analog-to-digital converter is coupled to the respective line for each pixel, and converts a respective voltage at the respective line into a respective code. The image sensor also includes a first pad and a second pad. The first pad is coupled to the respective line and an external tester that applies a bias voltage on the first pad. Thus, the bias voltage is applied on the respective line via the first pad. The second pad is coupled to the respective analog-to-digital converter and the external tester, and the second pad outputs the respective code corresponding to the bias voltage to the external tester.

The image sensor according to another embodiment of the present invention includes an image processing unit for converting the respective code into a respective image signal. In that case, the image sensor also includes a third pad coupled to the image processing unit and the external tester, and the third pad outputs the respective image signal to the external tester.

The image sensor according to a further embodiment of the present invention includes a ramp signal generator for generating a reference voltage used by the respective analog-to-digital converter when generating the respective code.

In an example embodiment of the present invention, the first pad is commonly connected to respective column lines of the plurality of pixels arranged in a row of a pixel array of the image sensor.

In another embodiment of the present invention, the first pad is coupled to an external switch of the external tester. In the test system for testing such an image sensor, the external tester also includes a data processor and a memory device having sequences of instructions stored thereon. Execution of the sequences of instructions by the data processor causes the data processor to perform the steps of:
controlling the external switch to be opened for a normal mode of operation of the image sensor; and
controlling the external switch to be closed for applying the bias voltage from the bias voltage generator on the first pad during a test mode.

In the external tester according to a further embodiment of the present invention, execution of the sequences of instructions by the data processor causes the data processor to further perform the steps of:
inputting a first respective code corresponding to a dark current of the image sensor from the second pad after the external switch has been opened; and
inputting a second respective code corresponding to the bias voltage from the second pad after the external switch has been closed.

In the external tester according to another embodiment of the present invention, execution of the sequences of instructions by the data processor causes the data processor to further perform the steps of:
controlling the bias voltage generator to generate the bias voltage that varies with time such that a respective code is generated by the image sensor for each value of the varied bias voltage.

The present invention according to an example embodiment is practiced for a CMOS image sensor with each pixel including a floating node, a photodiode, and a plurality of transistors. For example, a reset transistor sets a reset voltage at the floating node to a predetermined value. The photodiode generates photo-charge corresponding to an intensity of received light. A transfer transistor transfers the photo-charge from the photo-diode to the floating node. An amplifying transistor generates a pixel voltage from the photo-charge transferred to the floating node. A select transistor outputs the pixel voltage generated by the amplifying transistor to the respective line.

However, the present invention may be practiced with other types of image sensors. In this manner, a metal line and a pad are added to the image sensor for applying the bias voltage for simplified testing of the image sensor. In addition, pads are added to the image sensor for outputting signals from the CIS unit and the ISP unit for characterizing the full data path of the CMOS image sensor. Addition of the metal line and the pads does not significantly increase the integrated circuit area and complexity of the CMOS image sensor since the bias voltage generator and the switching device are formed off-chip in the external tester.

### BRIEF DESCRIPTION OF THE DRAWINGS

The above and other features and advantages of the present invention will become more apparent when described in detailed exemplary embodiments thereof with reference to the attached drawings in which:

FIG. 1 is a block diagram of a test system for testing a CMOS image sensor, according to an embodiment of the present invention;

FIG. 2 is a block diagram of an example CIS unit of FIGS. 1 and 5, according to an embodiment of the present invention;

FIG. 3 is circuit diagram of an example pixel with an example data conversion unit in the CMOS image sensor of FIG. 2, according to an embodiment of the present invention;

FIG. 4 is a timing diagram of signals during operation of the circuit of FIG. 3;

FIG. 5 shows a block diagram of the test system of FIG. 1 with more detailed components for testing the CMOS image sensor, according to another embodiment of the present invention; and

FIG. 6 shows a flowchart of steps during operation of the test system of FIG. 5, according to an embodiment of the present invention.

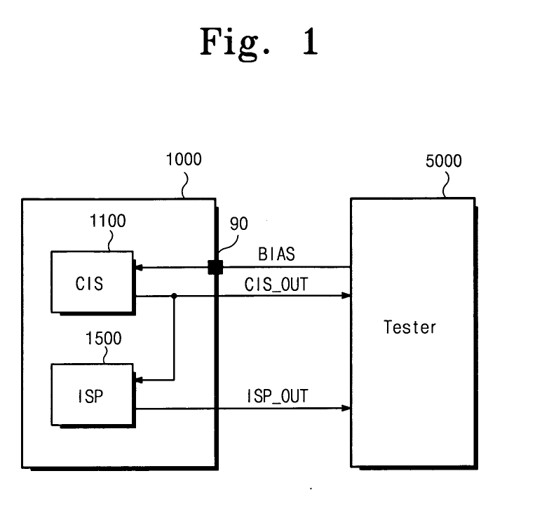

The figures referred to herein are drawn for clarity of illustration and are not necessarily drawn to scale. Elements having the same reference number in FIGS. 1, 2, 3, 4, 5, and 6 refer to elements having similar structure and/or function.

### DETAILED DESCRIPTION OF THE INVENTION

FIG. 1 is a block diagram of a test system for testing a CMOS (complementary metal oxide semiconductor) image sensor (CIS) 1000 according to an embodiment of the present invention. Referring to FIG. 1, a test system includes the CMOS image sensor 1000 and an external tester 5000 that is outside (i.e. separate from) the CMOS image sensor 1000.

The CMOS image sensor 1000 includes a CIS (CMOS image sensing) unit 1100 and an ISP (image signal processing) unit 1500. The external tester 5000 provides a bias voltage BIAS applied on a first pad 90 disposed on the CMOS image sensor 1000. The bias voltage BIAS is provided to an analog-digital converter within the CIS unit 1100 that generates a code CIS_OUT. The ISP unit 1500 generates an image signal ISP_OUT from such a code CIS_OUT.

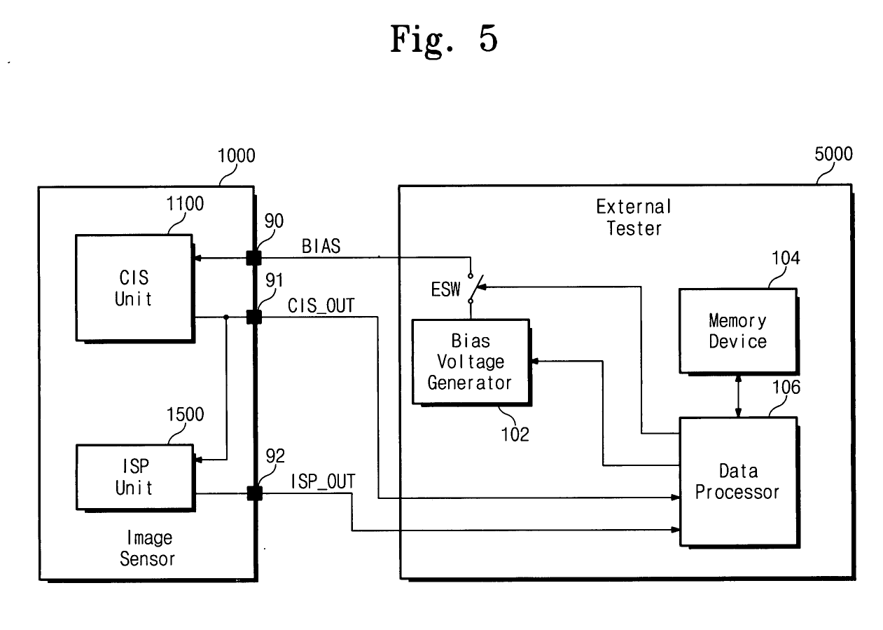

FIG. 5 shows a block diagram of the test system of FIG. 1 with more detailed components for testing the CMOS image sensor 1000. The CMOS image sensor 1000 includes a second pad 91 for outputting the code CIS_OUT generated from the CIS unit 1100 to the external tester 5000. The CMOS image sensor 1000 includes a third pad 92 for outputting the image signal ISP_OUT generated from the ISP unit 1500 to the external tester 5000.

The external tester 5000 includes a bias voltage generator 102 for generating the bias voltage BIAS to be applied on the first pad 90 of the CMOS image sensor 1000. The external tester 5000 further includes an external switch ESW coupled between the bias voltage generator 102 and the first pad 90.

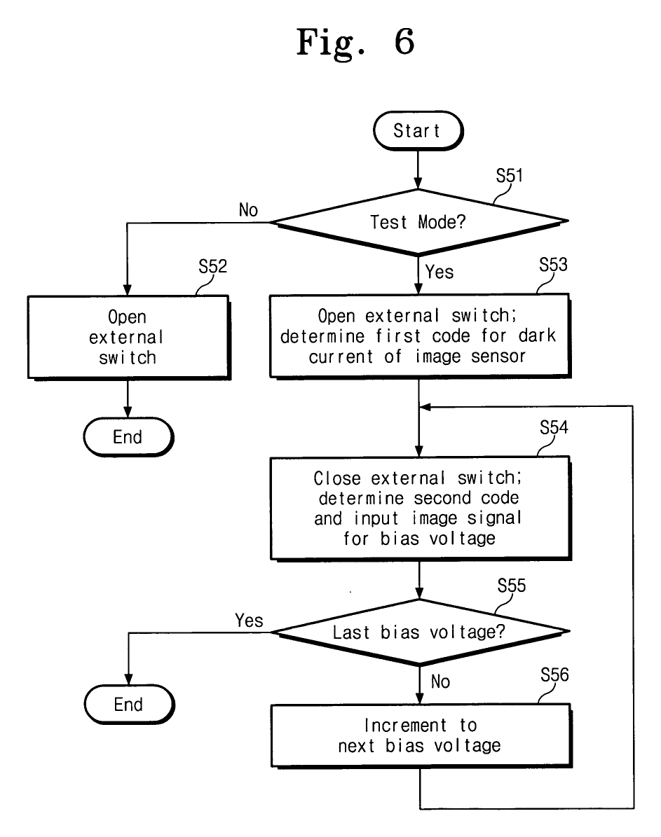

The external tester 5000 also includes a memory device 104 and a data processor 106. The memory device 104 has sequences of instructions (i.e., software) stored thereon, and execution of such sequences of instructions by the data processor 106 causes the data processor 106 to perform the steps of the flowchart of FIG. 6.

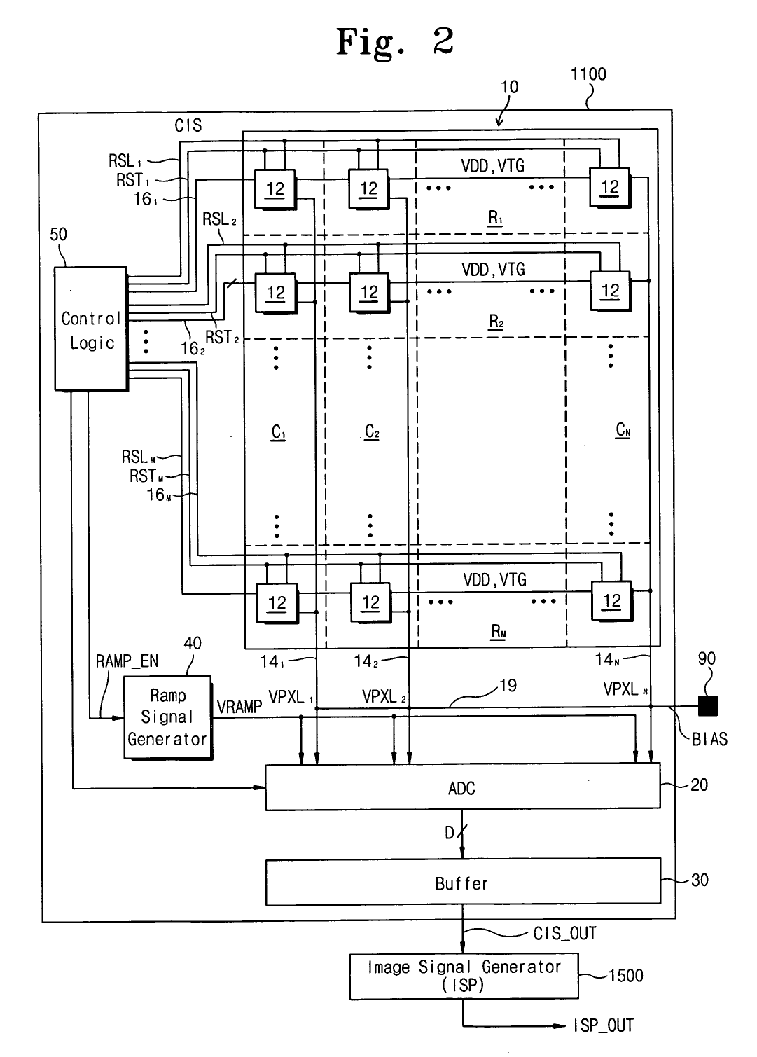

FIG. 2 shows a block diagram of detailed components of the CIS unit 1100 of FIGS. 1 and 5. Referring to FIG. 2, the CIS unit 1100 includes a pixel array 10 of a plurality of pixels 12 arranged in rows R₁-R_{M} and columns C₁-C_{N}. The pixels 12 of one row are simultaneously activated when such a row is selected by a control logic block 50.

The control logic block 50 generates a respective set of a row select signal RSL₁, RSL₂, . . . , or RSL_{M}, voltages VDD and VTG necessary for driving the pixels, and a reset signal RST₁, RST₂, . . . or RST_{M}, for each row. The voltages VDD and VTG are provided to each row through respective supply lines 16₁, 16₂, . . . , or 16_{M}.

During a normal mode of operation, each pixel in an activated row generates a respective pixel voltage VPXL₁, VPXL₂, . . . , or VPXL_{N} induced by received light at each such pixel at a respective column data line 14₁, 14₂, . . . , or 14_{N} coupled to an analog-digital converter block 20. In addition, a signal line 19 is connected to all of the column data lines 14₁, 14₂, . . . , and 14_{N} and the first data pad 90 such that the bias voltage BIAS from the external tester 5000 is applied to the column data lines 14₁, 14₂, . . . , and 14_{N} during a test mode of operation.

The signal line 19 is fabricated by patterning a metal layer typically formed during fabrication of the CMOS image sensor 1000 such that no significant processing steps are added for forming the signal line 19. In addition, the pad 90, 91, and 92 are formed during formation of other pads on the CMOS image sensor 1000 such that no significant processing steps are added for forming the pads 90, 91, and 92.

The CIS unit 1100 also includes a ramp signal generator 40 for generating a ramp signal VRAMP in response to a ramp enable signal RAMP_EN from the control logic block 50. The ramp signal VRAMP is a time varying reference signal which varies with a predetermined slope. The analog-digital converter block 20 includes a respective analog-to-digital converter for converting the respective voltage at each of the column data lines 14₁, 14₂, . . . , and 14_{N} into a digital code with a CDS (correlated double sampling) mechanism using the ramp signal VRAMP.

In the normal mode of operation, the pixel voltages VPXL₁, VPXL₂, . . . , and VPXL_{N} are applied at the column data lines 14₁, 14₂, . . . , and 14_{N} , respectively, for being converted into digital codes by the analog-digital converter block 20. In a test mode of operation, the bias voltage BIAS is forcibly applied at the column data lines 14₁, 14₂, . . . , and 14_{N} for being converted into digital codes by the analog-digital converter block 20.

Such digital codes form the output CIS_OUT of the CIS unit 1100 and are provided to the ISP unit 1500 through a buffer 30. The ISP unit 1500 reconstructs such digital codes CIS_OUT into the image signal ISP_OUT using an image processing circuit (not shown). Various kinds of image processing algorithms used by such an image processing circuit are known to one of ordinary skill in the art.

In the normal mode of operation, the image signal ISP_OUT from the ISP unit 1500 is the final output signal of the CMOS image sensor 1000. In the test mode of operation, signals CIS_OUT and ISP_OUT from the CIS unit 1100 and the ISP unit 1500, respectively, are output to the external tester 5000 via the second and third pads 91 and 92, respectively.

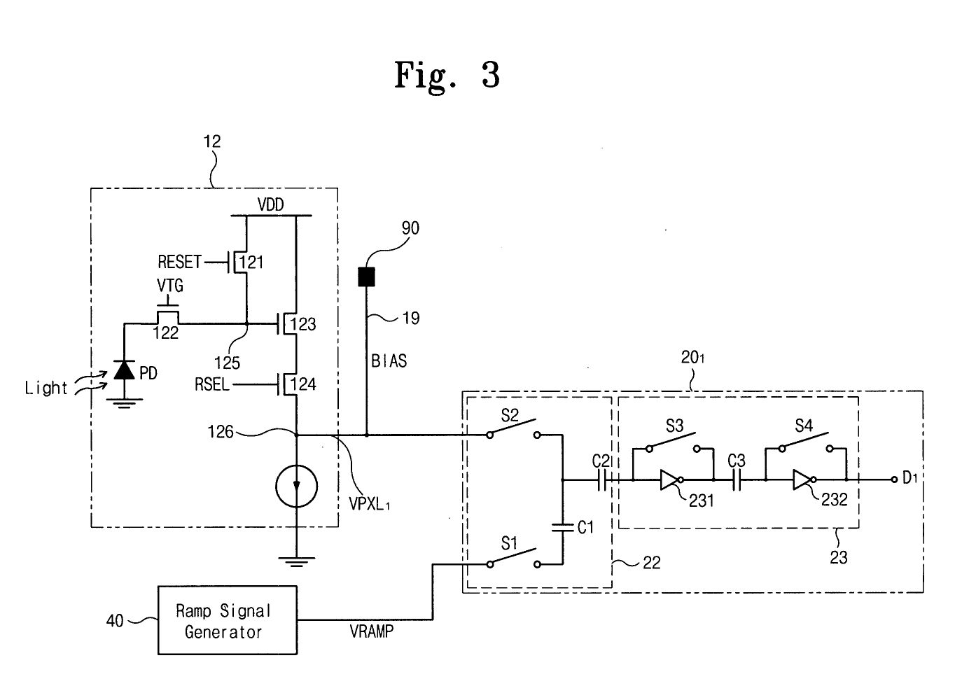

FIG. 3 shows a circuit diagram of an example pixel 12 and a respective analog-to-digital converter 20₁ for such an example pixel 12. Referring to FIG. 3, each pixel 12 includes NMOSFETs (N-channel metal oxide semiconductor field effect transistors) 121, 122, 123, and 124 and a photodiode PD. The photodiode PD converts received light into photo-charge.

A reset NMOSFET 121 has a drain connected to a high voltage source VDD, a source connected to a floating node 125, and a gate receiving a reset signal RESET (i.e., RST₁, RST₂, . . . , or RST_{M}). The reset NMOSFET 121 when turned on sets the voltage at the floating node 125 to a predetermined reset voltage.

A transfer NMOSFET 122 has a drain and a source connected between a cathode of the photodiode PD and the floating node 125, and has a gate with the control voltage VTG applied thereon. The anode of the photodiode PD is connected to the ground node. The transfer NMOSFET 122 when turned on transfers photo-charge from the photodiode PD to the floating node 125.

An amplifying NMOSFET 123 has a drain connected to the high voltage source VDD, a gate connected to the floating node 125, and a source connected to a drain of a select NMOSFET 124. The amplifying NMOSFET 123 forms a source-follower amplifier between the floating node 125 and the select NMOSFET 124. The select NMOSFET 124 when turned on with the row select signal RSEL (i.e., RSL₁, RSL₂, . . . , or RSL_{M}), outputs the respective pixel voltage VPXL1 corresponding to the received light sensed by the photodiode PD to a respective column data line 126 (i.e., 14₁) that is coupled to the corresponding analog-to-digital converter 201. The respective column data line 126 is also connected to the first pad 90 through the signal line 19.

The analog-to-digital converter 20₁ includes a CDS circuit 22 and an output circuit 23. The CDS circuit 22 includes a first capacitor C1, a second capacitor C2, a first switch S1, and a second switch S2. One end of the first capacitor C1 is connected to the output circuit 23 through the second capacitor C2. The first switch S1 switches the ramp signal VRAMP from the ramp signal generator 40 to the other end of the first capacitor C1. One end of the second capacitor C2 is connected to the output circuit 23, and the second switch S2 switches the voltage at the column data line 126 of the pixel 12 to the other end of the second capacitor C2.

The output circuit 23 includes a third capacitor C3, a third switch S3, a fourth switch S4, a first inverter 231, and a second inverter 232. The first inverter 231 inverts the output of the CDS circuit 22. The switch S3 switches an input terminal of the inverter 231 to an output terminal of the inverter 231. The third capacitor C3 is connected between the first inverter 231 and the second inverter 232.

The second inverter 232 has an input terminal coupled to the third capacitor C3 and has an output terminal outputting a coding signal D₁ for the example pixel 12. The fourth switch S4 switches the input terminal of the second inverter 232 to the output terminal of the second inverter 232. The coding signal D₁ represents a difference between the pixel voltage VPXL₁ or the bias voltage BIAS at the respective column data line 126 and the reset voltage for correlated double sampling.

The switches S1, S2, S3, and S4 are controlled by the control logic block 50 for generating the coding signal D₁. The CDS circuit 22 and the output circuit 23 and the operation of such circuits 22 and 23 for the analog-to-digital converter 20₁ are individually known to one of ordinary skill in the art. Such circuits 22 and 23 for the analog-to-digital converter 20₁ are by way of example only, and the present invention may be practiced with other types of analog-to-digital circuits.

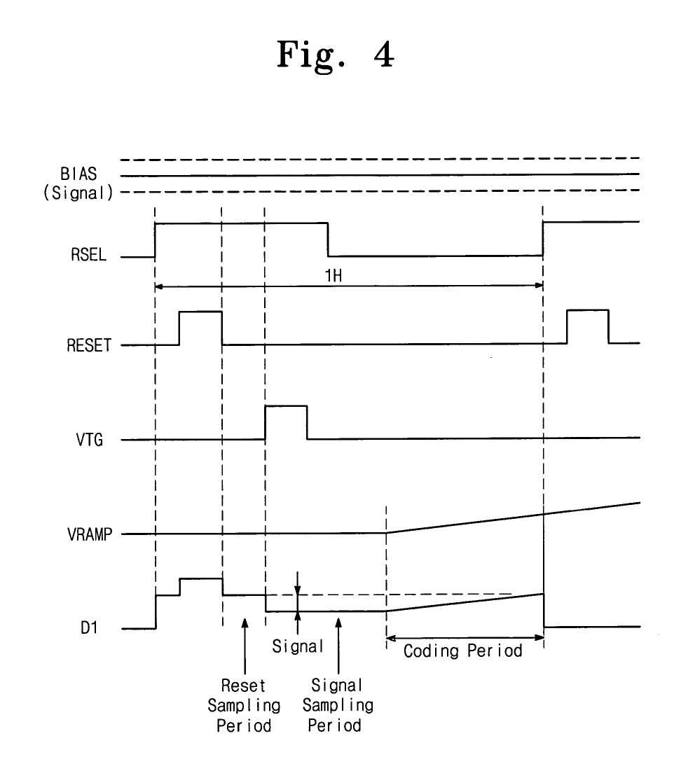

FIG. 4 is a timing diagram of signals during operation of the circuit of FIG. 3 according to an embodiment of the present invention. Referring to FIG. 4, the row select signal RSEL is at the logic high state for activating the row of the example pixel 12. The reset signal RESET is activated to the logic high state such that the predetermined reset voltage is represented by the coding signal D₁ (i.e. during the “Reset Sampling Period” in FIG. 4).

Thereafter, the transfer control signal VTG is activated to the logic high state, and the voltage at the respective column data line 126 (i.e., the bias voltage BIAS in FIG. 4) is incorporated into the coding signal D₁ (i.e. during the “Signal Sampling Period” in FIG. 4). During such a signal sampling period, the difference between the bias voltage BIAS and the reset voltage is represented by the increment labeled “Signal” in FIG. 4.

After the signal sampling period in FIG. 4, the ramp signal VRAMP begins to be applied, and a time period (i.e. the “Coding Period” in FIG. 4) for the increment “Signal” in FIG. 4 to reach back to the original reset voltage represents a digital code corresponding to the bias voltage BIAS. The coding signal D₁ may be used with a counter (not shown) within the analog-to-digital converter 20₁ for generating the digital code corresponding to the voltage at the column data line 126 during the signal sampling period. In that case, the digital output of the counter represents the digital code CIS_OUT generated from the CIS_UNIT 1100.

An example operation of the test system of FIG. 5 is now described in reference to the flowchart of FIG. 6 according to an example embodiment of the present invention. Referring to FIGS. 5 and 6, if the CMOS image sensor 1000 is to operate in a normal mode, then the external switch ESW is opened such that the bias voltage BIAS is not applied on the first pad 90.

In the normal mode of operation (steps S51 and S52 of FIG. 6), the respective pixel voltage VPXL1 corresponding to the received light sensed by the photodiode PD is incorporated into the coding signal D₁ during the signal sampling period. In that case, the coding signal D₁ represents the difference between the reset voltage and the pixel voltage VPXL1 for correlated double sampling.

On the other hand, during a test mode of operation (step S51 of FIG. 6), the data processor 106 controls the external switch ESW to be initially opened, and substantially zero light is received by the pixel array 10, for determining a first digital code representing dark current of the CMOS image sensor 1100 (step S53 of FIG. 6). With the external switch ESW being open, the test system of FIG. 5 operates similarly as during the normal mode for determining the first digital code representing such dark current. For example, the first digital code may be the output signal CIS_OUT from the analog-to-digital converter 20₁ that is output via the second pad 91 of the CMOS image sensor 1000 with the external switch ESW being opened.

Thereafter, the data processor 106 controls the external switch ESW to be closed such that the bias voltage BIAS is applied on the first pad 90 (step S54 of FIG. 6). Thus, the bias voltage BIAS is applied to the column data lines 14₁, 14₂, and 14_{N}. With such bias voltage BIAS applied with the closed external switch ESW, a second digital code representing the bias voltage BIAS is determined from the output signal CIS_OUT generated by the CIS unit.

Such output signal CIS_OUT may be the digital code from the analog-to-digital converter 20₁ that is output by the CIS unit 1100 via the second pad 91 of the CMOS image sensor 1000 with the bias voltage BIAS being applied (step S54 of FIG. 6). In addition, the image signal ISP_OUT is also input by the data processor 106 via the third pad 92 of the CMOS image sensor 1000 (step S54 of FIG. 6).

The data processor 106 subtracts the first digital code representing the dark current of the CMOS image sensor 1000 from the second digital code representing application of the bias voltage BIAS to compensate for effects of the dark current. The data processor 106 analyzes such digital codes and the image signal ISP_OUT for testing the functionality of the components of the CMOS image sensor 1000 such as the pixel array 10, the ramp signal generator 40, the control logic 50, the analog-digital block 20, the buffer 30, and the ISP unit 1500.

Further referring to FIG. 6, the data processor 106 controls the bias voltage generator 102 to vary the bias voltage BIAS in incremental steps according to another embodiment of the present invention. If the last bias voltage has not been generated and applied to the first pad 90 (step S55 of FIG. 6), the bias voltage BIAS is incremented (step S56 of FIG. 6) to a next level, and step S54 is repeated for generating respective CIS_OUT and ISP_OUT signals for such an incremented bias voltage BIAS. Such steps S54, S55, and S56 are repeated until a last increment of the bias voltage is reached when the flowchart of FIG. 6 ends. The test system 5000 tests for the functionality of the components of the CMOS image sensor 1000 with a whole range of voltages from such variation of the bias voltage BIAS.

In this manner, the metal line 19 and the pad 90 is added to the CMOS image sensor 1000 for applying the bias voltage for simplified testing of the CMOS image sensor 1000. In addition, the pads 91 and 92 are added to the CMOS image sensor 1000 for outputting signals from the CIS unit 1100 and the ISP unit 1500 for characterizing the full data path of the CMOS image sensor 1000. Addition of such a metal line 19 and the pads 90, 91, and 92 does not significantly increase the integrated circuit area and complexity of the CMOS image sensor 1000 since the bias voltage generator 102 and the external switching device ESW are formed off-chip in the external tester 5000.

The foregoing is by way of example only and is not intended to be limiting. For example, the present invention has been illustrated and described for a CMOS image sensor. However, the present invention may also be practiced for other types of image sensors. In addition, any voltage values or types of transistor devices illustrated herein are by way of example only. Furthermore, the signals shown in the timing diagram are by way of example only for describing example operations.

The present invention is limited only as defined in the following claims and equivalents thereof.

What is claimed is:

1. An image sensor comprising:
a plurality of pixels each coupled to a respective line;
a respective analog-to-digital converter, coupled to the respective line for each pixel, for converting a respective voltage at the respective line into a respective code;
a first pad, coupled to the respective line and an external tester that applies a bias voltage on the first pad, wherein the bias voltage is applied on the respective line via the first pad; and
a second pad, coupled to the respective analog-to-digital converter and the external tester, for outputting the respective code corresponding to the bias voltage to the external tester.

2. The image sensor of claim 1, further comprising:
an image processing unit for converting the respective code into a respective image signal; and
a third pad, coupled to the image processing unit and the external tester, for outputting the respective image signal to the external tester.

3. The image sensor of claim 1, further comprising:
a ramp signal generator for generating a reference voltage used by the respective analog-to-digital converter when generating the respective code.

4. The image sensor of claim 1, wherein the first pad is commonly connected to respective column lines of the plurality of pixels arranged in a row of a pixel array of the image sensor.

5. The image sensor of claim 1, wherein the first pad is coupled to an external switch of the external tester, and wherein the external switch is opened in a normal mode of operation of the image sensor, and wherein the external switch is closed for applying the bias voltage on the first pad during a test mode.

6. The image sensor of claim 1, wherein the bias voltage applied on the first pad is varied from the external tester.

7. The image sensor of claim 1, wherein each of the plurality of pixels includes:
a floating node;
a reset transistor for setting a reset voltage at the floating node to a predetermined value;
a photodiode generating photo-charge corresponding to an intensity of received light;
a transfer transistor for transferring the photo-charge from the photo-diode to the floating node;
an amplifying transistor for generating a pixel voltage from the photo-charge transferred to the floating node; and
a select transistor for outputting the pixel voltage generated by the amplifying transistor to the respective line.

8. A test system comprising:
an external tester for generating a bias voltage; and
an image sensor including:
a plurality of pixels each coupled to a respective line;
a respective analog-to-digital converter, coupled to the respective line for each pixel, for converting a respective voltage at the respective line into a respective code;
a first pad, coupled to the respective line and the external tester, for applying the bias voltage from the external tester on the respective line; and
a second pad, coupled to the respective analog-to-digital converter and the external tester, for outputting the respective code corresponding to the bias voltage to the external tester.

9. The test system of claim 8, wherein the image sensor further includes:
an image processing unit for converting the respective code into a respective image signal; and
a third pad, coupled to the image processing unit and the external tester, for outputting the respective image signal to the external tester.

10. The test system of claim 8, wherein the image sensor further includes:
a ramp signal generator for generating a reference voltage used by the respective analog-to-digital converter when generating the respective code.

11. The test system of claim 8, wherein the first pad is commonly connected to respective column lines of the plurality of pixels arranged in a row of a pixel array of the image sensor.

12. The test system of claim 8, wherein the external test system further includes:
a bias voltage generator for generating the bias voltage;
an external switch coupled between the bias voltage generator and the first pad of the image sensor;
a data processor; and
a memory device having sequences of instructions stored thereon, wherein execution of the sequences of instructions by the data processor causes the data processor to perform the steps of:
controlling the external switch to be opened for normal mode of operation of the image sensor; and
controlling the external switch to be closed for applying the bias voltage from the bias voltage generator on the first pad during a test mode.

13. The test system of claim 12, wherein execution of the sequences of instructions by the data processor causes the data processor to further perform the steps of:
inputting a first respective code corresponding to a dark current of the image sensor from the second pad after the external switch has been opened; and
inputting a second respective code corresponding to the bias voltage from the second pad after the external switch has been closed.

14. The test system of claim 12, wherein execution of the sequences of instructions by the data processor causes the data processor to further perform the steps of:
controlling the bias voltage generator to generate the bias voltage that varies with time.

15. The test system of claim 1, wherein each of the plurality of pixels of the image sensor includes:
a floating node;
a reset transistor for setting a reset voltage at the floating node to a predetermined value;
a photodiode generating photo-charge corresponding to an intensity of received light;
a transfer transistor for transferring the photo-charge from the photo-diode to the floating node;
an amplifying transistor for generating a pixel voltage from the photo-charge transferred to the floating node; and
a select transistor for outputting the pixel voltage generated by the amplifying transistor to the respective line.

16. A method of testing an image sensor, comprising:
generating a bias voltage at an external tester outside of the image sensor;
applying the bias voltage on a first pad of the image sensor;
coupling the bias voltage from the first pad to an input of an analog-to-digital converter of the image sensor that converts the bias voltage into a code; and
outputting the code via a second pad of the image sensor to the external tester.

17. The method of claim 16, wherein the first pad is commonly connected to respective column lines of the plurality of pixels arranged in a row of a pixel array of the image sensor.

18. The method of claim 16, further comprising:
converting the code into an image signal; and
outputting the image signal via a third pad of the image sensor to the external tester.

19. The method of claim 16, further comprising:
controlling an external switch within the external tester to be opened such that the bias voltage is not applied on the first pad;
outputting to the external tester a first code corresponding to a dark current of the image sensor via the second pad after the external switch has been opened;
controlling the external switch to be closed such that the bias voltage is applied on the first pad; and
outputting to the external tester a second code corresponding to the bias voltage via the second pad after the external switch has been closed.

20. The method of claim 16, further comprising:
varying the bias voltage applied on the first pad; and
outputting to the external tester via the second pad a respective code for each value of the varied bias voltage.
